(19) United States
(12) Patent Application Publication
(10) Pub. No.: US 2009/0064580 A1
(43) Pub. Date: Mar. 12, 2009

(54) VENTURI INSERTS, INTERCHANGEABLE VENTURIS, AND METHODS OF FLUIDIZING

(76) Inventors: David H. Nicoll, Houston, TX (US); Timothy E. Vail, Houston, TX (US)

Correspondence Address: GILBRETH & ASSOCIATES, P.C., PO BOX 2428, BELLAIRE, TX, 77402-2428, US

(21) Appl. No.: 11/853,934

(22) Filed: Sep. 12, 2007

(51) Int. Cl. C10J 3/68; B01J 19/00

(52) U.S. Cl. 48/77; 422/145; 48/210

(57) ABSTRACT

A fluidized bed apparatus having an agglomeration passage in which is positioned a removeable venturi inset.

### BACKGROUND OF THE INVENTION

1. Field of the Invention

The present invention relates to apparatus for and methods of fluidizing, and to methods of selectively removing particles from a fluidized bed. In another aspect, the present invention relates to fluidized bed reactors and to methods of gasification. In another aspect, the present invention relates to interchangeable venturi inserts for fluidized bed reactors, to fluidized bed reactors having interchangeable venturi inserts, and to methods of gasification. In even another aspect, the present invention relates to fluidized bed coal gasification, to methods of coal gasification, and to methods of selectively removing ash particles from a fluidized bed.

2. Description of the Related Art

Fluidization is commonly defined as an operation by which particulate fine solids are transformed into a fluid-like state through contact with a gas or liquid. Due to the high surface area-to-volume ratio of particulate matter to fluidizing medium, fluidized beds are known for their high heat and mass transfer coefficients. Fluidized beds are used in a wide variety of industrial processes such as chemical reactions, catalytic reactions, classifying, drying, mixing, granulation, coating, heating and cooling.

In many industrial applications, a fluidized bed consists of a vertically-oriented column filled with granular material with a fluid (gas or liquid) being pumped upwards through a distributor at the bottom of the bed. When the drag force of flowing fluid exceeds gravity, particles are lifted and fluidization occurs.

Fluidized bed technology is utilized in coal gasification. There are a number of patent applications that are directed toward fluidized beds and/or coal gasification.

A coal gasification reactor of the type wherein agglomerated coal ash is withdrawn from a fluid reaction bed of finely divided coal without the removal of the finely divided coal particles is disclosed in Jequier et al, U.S. Pat. No. 2,906,608 and Matthews et al, U.S. Pat. No. 3,935,825. These patents are incorporated herewith by reference.

In a coal to gas conversion process of the type referenced, a vessel is provided for a fluidized bed. A gas distribution grid is usually positioned in the vessel and defines the bottom surface of the fluidized bed. The central portion of the grid may be conical or cylindrical in shape and comprises a passage. At the top of the passage, a constriction is provided having a fixed opening defining a venturi of fixed throat size to provide a uniform upward gas velocity through the venturi and into the vessel and thus into the fluidized bed. Directing a stream of high velocity gas through the venturi, acts as a classifier which only allows agglomerated particles of a certain mass or size and/or greater size to, discharge through the passage and venturi throat.

U.S. Pat. No. 4,023,280, issued May 17, 1977, to Schora et al., discloses a fluidized bed of material retained in a vessel which receives a high velocity gas stream through a venturi orifice and passage to assist in the agglomeration of ash particles. The particles form a semi-fixed bed within the passage upstream from the venturi orifice. The particular dimensions of the semi-fixed bed are dependent, in part, upon the orifice size of the venturi. An iris valve defining the orifice permits adjustment of the cross-sectional area of the orifice and thereby controls the velocity of the gas stream through the venturi.

U.S. Pat. No. 4,435,364, issued Mar. 6, 1984, to Vorres, discloses an apparatus for withdrawing agglomerated solids, e.g. ash, from a fluidized bed of finely divided solid hydro-carbonaceous material, e.g. coal, is described. Agglomeration is effected by a high temperature reaction between the inorganic constituents of the hydro-carbonaceous material in the fluidized bed environment. A venturi is utilized to serve as a passage for withdrawing the agglomerated solids from the fluidized bed. Spiral or other descending ridges are positioned on the interior surface of the constricted cylindrical opening of the venturi to permit variable and increased rates of agglomerate discharge with improved separation and classification of the solid materials.

U.S. Pat. No. 4,453,495, issued, Jun. 12, 1984, to Strohmeyer, Jr., discloses an integrated control for a steam generator circulating fluidized bed firing system. The system includes an integrated control means, particularly at partial loads, for a steam generator having a circulating fluidized bed combustion system wherein gas recirculation means is used to supplement combustion air flow to maintain gas velocity in the circulation loop sufficient to entrain and sustain particle mass flow rate at a level required to limit furnace gas temperature to a predetermined value as 1550 F. and wherein gas recirculation mass flow apportions heat transfer from the gas and recirculated particles among the respective portions of the steam generator fluid heat absorption circuits, gas and circulating particle mass flow rates being controlled selectively in a coordinated manner to complement each other in the apportionment of heat transfer optimally among the fluid heat absorption circuits while maintaining furnace gas temperature at a predetermined set point.

U.S. Pat. No. 4,454,838, issued Jun. 19, 1984, to Strohmeyer, Jr., discloses a dense pack heat exchanger for a steam generator having a circulating fluidized bed combustion system whereby a bed of solid particles comprising fuel and inert material is entrained in the furnace gas stream. Means are provided for collecting high temperature bed solid particles downstream of the furnace. The dense pack heat exchanger directs the hot collected particles down over heat transfer surface, such surface being a portion of the steam generator fluid circuits. Flow is induced by gravity means. The dense compaction of the solid particles around the fluid heat exchange circuits results in high heat transfer rates as the fluid cools the compacted solid material. The heat exchange surface is arranged to facilitate flow of the solid particles through the heat exchanger.

U.S. Pat. No. 4,462,341, issued Jul. 31, 1984, Strohmeyer, Jr. discloses a steam generator having a circulating fluidized bed combustion system whereby there is provision to admit air flow incrementally along the gas path to control combustion rate and firing temperature in a manner to maintain differential temperatures along the gas path. The initial portion of the gas path where combustion is initiated can be held in one temperature range as 1550 F which is optimum for sulphur retention and the final portion of the combustion zone can be elevated in temperature as to 1800 F to produce a greater degree of heat transfer through the gas to fluid heat exchange surface downstream of the combustion zone.

U.S. Pat. No. 4,745,884, issued May 24, 1988, to Coulthard, discloses a fluidized bed steam generating system includes an upstanding combustion vessel, a gas/solids separator, a convection pass boiler and a heat exchanger positioned directly below the boiler and all of the above elements except the gas/solids separator are enclosed within a waterwall structure having outside waterwalls and a central waterwall common to the reactor vessel on one hand and the convection pass boiler and heat exchanger on the other hand. The close proximity of the components of the system eliminate numerous problems present in conventional multi-solid fluidized bed steam generators.

U.S. Pat. No. 5,082,634, issued Jan. 21, 1992, to Raufast, discloses a fluidized bed apparatus comprising a fluidization grid arranged in the lower part of this apparatus, this grid being provided at its center with a circular aperture communicating with a discharge chamber and occurring in the form of a surface of revolution consisting of the joined lateral surfaces of at least two coaxial truncated cones of revolution, virtual vertices of which are oriented downwards.

In spite of all of the advances in fluidized bed technology, one problem that may be encountered is the ability to selectively remove particles from the fluidized bed and, in the case of coal gasification, where different coals have different ash with different ash characteristics, to selectively remove ash and agglomerated ash with particles having different mass and size from the fluidized bed. While prior art apparatus utilize a valve for changing from a first cross-sectional area of the orifice to a second cross-sectional area, such as the iris valve of U.S. Pat. No. 4,023,280 to Schora et al., discussed above, such a valve provides an abrupt change in the cross-sectional area. The venturi inserts of the present invention allow for the design of a transitional zone between the first and second cross-sectional areas.

### SUMMARY OF THE INVENTION

According to one non-limiting embodiment of the present invention, there is provided a fluidized bed apparatus. The fluidized bed apparatus includes a vessel having a top and a bottom, defining a fluidized bed region between the top and bottom, and defining a passage at the bottom for introducing fluidizing medium and removing particulates. The apparatus also includes a first venturi positioned in the passage, wherein the first venturi is interchangeable with a second venturi.

According to another non-limiting embodiment of the present invention, there is provided a fluidized bed apparatus. The apparatus includes a vessel having a top and a bottom, defining a fluidized bed region between the top and bottom, and defining a central passage at the bottom for introducing fluidizing medium, and further defining an annular passage around the central passage for removing particulates. The apparatus also includes a first venturi positioned in the annular passage, wherein the first venturi is interchangeable with a second venturi.

According to even another non-limiting embodiment of the present invention, there is provided a method of fluidizing. The method includes introducing particles into a fluidizing bed region of a vessel. The method also includes removing particles through a first interchangeable venturi.

### BRIEF DESCRIPTION OF THE DRAWINGS

FIG. 1 is a schematic representation of one non-limiting example of a fluidized bed reactor 100 of the present invention with a passage at the bottom and center of the reactor.

FIG. 2 is a schematic representation of another non-limiting example of a fluidized bed reactor 100 of the present invention, differing from that of FIG. 1 at least by the central pipe 28 in the lower section of the reactor.

FIG. 3 is a schematic representation of the lower portion of reactor 100 of FIG. 1, showing a non-limiting embodiment of insert 201.

FIG. 4 is a schematic representation of the lower portion of reactor 100 of FIG. 2, showing a non-limiting embodiment of insert 201 in the outer portion of the annular space.

FIG. 5 is a top view of insert 201 of FIG. 3.

FIG. 6 is a top view of insert 201 of FIG. 4.

FIG. 7 is is a schematic representation of the lower portion of reactor 100 of FIG. 2, showing a non-limiting embodiment of inserts 201 in both the inner and the outer portion of the annular space.

FIG. 8 is a top view of insert 201 of FIG. 7.

FIG. 9 is a top view of a non-limiting embodiment of insert 201 suitable for creating a plurality of passages 22.

FIG. 10 is a top view of a non-limiting embodiment of insert 201 suitable for reshaping circular passage into another shape (diamond shape in the non-limiting example as shown).

FIG. 11 is a side view of a non-limiting embodiment of insert 201 showing a plurality of transition surfaces.

### DETAILED DESCRIPTION OF THE INVENTION

The various embodiments of the present invention comprise interchangeable venturi inserts. As non-limiting examples, these various inserts may be utilized to change the diameter of a passage, change surface profiles of a passage, change surface properties of a passage, change flow patterns through the passage, change the cross sectional shape of a passage, divide the passage into smaller passages, and/or change flow velocities through the passage. The present invention contemplates that various apparatus may incorporate the interchangeable venturi inserts, including, but not limited to reactors, mixers, separators, classifiers, sparging units, and fluidized beds.

These interchangeable venturi inserts may be useful for accomplishing a number of results, including but not limited to changing the flow velocity through the passage to accomplish elutriation or air classification of particles. Generally, elutriation or air classification is a process for separating lighter particles from heavier ones using a vertically-directed stream of gas or liquid (usually upwards). The air velocity is selected to allow particles of desired parameters to fall through the passage against gas flow. Generally, the size, mass, shape, and/or surface area of the particle will determine if it will fall through the passage against gas flow of a given velocity. The cut point may be adjusted by changing the velocity of the gas flow. In the present invention, this may be accomplished by use of interchangeable venturi inserts, which may be of any suitable design to provide for the classification of particles according to their mass or size. For a given volumetric gas flow, decreasing/increasing the cross sectional area of the passage will increase/decrease the gas velocity through the passage and allow particles of different mass and size to fall through the venturi.

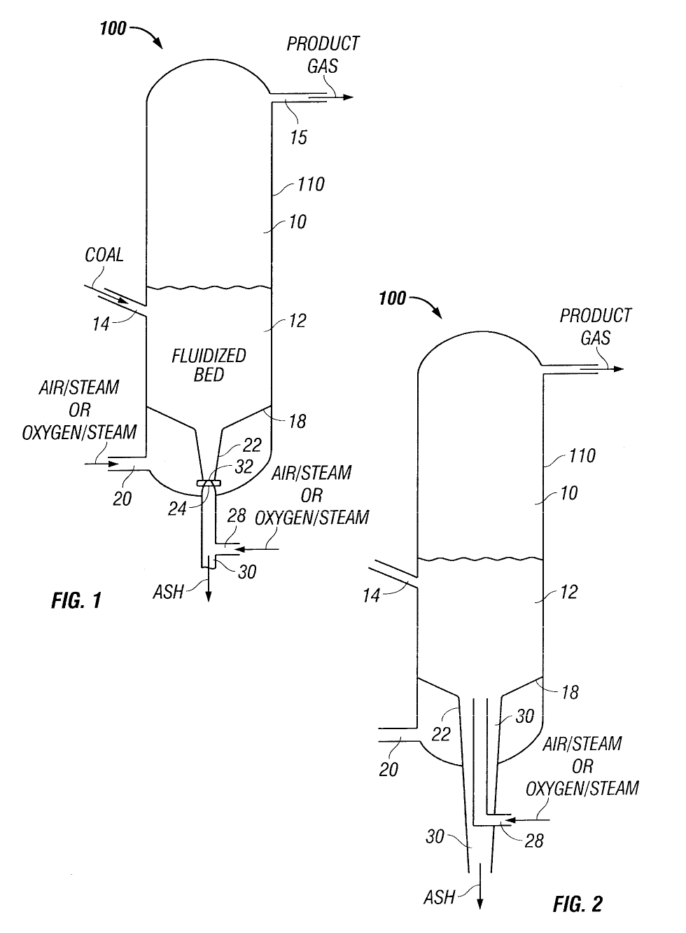

Two non-limiting embodiments of a fluidized bed of the present invention are shown in FIGS. 1 and 2, which show a schematic drawing of a fluidized bed gasifying apparatus or device 100 that includes means for agglomerating ash or particulate in the fluidized bed. The difference between the devices 100 of FIGS. 1 and 2, is seen in the lower portion of the devices. FIG. 2 utilizes a central pipe 28 with ash leaving through an annular passage 30. Such a device of FIG. 1 has been described in Jequier et al U.S. Pat. No. 2,906,608 and Matthews et al U.S. Pat. No. 3,935,825, both herein incoprporated by reference.

Briefly, device 100 includes a vessel 10 within which a fluidized bed 12 is retained. Vessel 100 further comprises outer wall 110. Pulverized fresh feed coal enters via line 14 and is contained within the bottom portion of the vessel or reactor 10 as a fluid bed 12 having a bed density of about 15 to 50 pounds per cubic foot. The coal within bed 10 is converted by reaction with steam and air to gaseous fuel components. These gaseous fuel components pass from the vessel 10 through a discharge line 16 with ash particles being discharged through central pipe 22.

A shaped sloped grid 18 is provided within vessel 10 at the bottom of bed 12. Air and steam enter through a line 20 and pass through ports in grid 18 to assist in maintenance of bed 12 in a fluidized state. Due to its greater density, the ash contained in the feed coal within bed 12 generally settles near the bottom of fluid bed 12. Thus, the ash particles flow down the sides of the generally conical grid 18 and pass into or enter a withdrawal chamber or particle exit passage 22 formed in the bottom central portion of grid 18. The venturi inserts of the present invention may be utilized to change the cross sectional area of particle exit passage 22, change the surface profile of particle exit passage 22, change the surface characteristics of particle exit passage 22, divide particle exit passage 22, change the cross sectional shape of particle exit passage 22, and by all of these methods generally change the velocity and/or flow patters of the fluidizing medium entering the fluidized bed through the passage and the selectivity of the particles and the ash descending through the venturi insert.

The various embodiments of fluidized beds of the present invention include interchangeable venturi inserts suitable for allowing the classification of particles from the fluidized bed.

The general idea is to utilize various venturi inserts to provide the desired flow velocity, flow pattern, flow characteristics, desired Reynolds number, desired amount of turbulence, desired amount of laminar flow, and/or flow direction, as desired. Any of these may be modified to control the mass, size and shape of particles being removed from the fluidized bed.

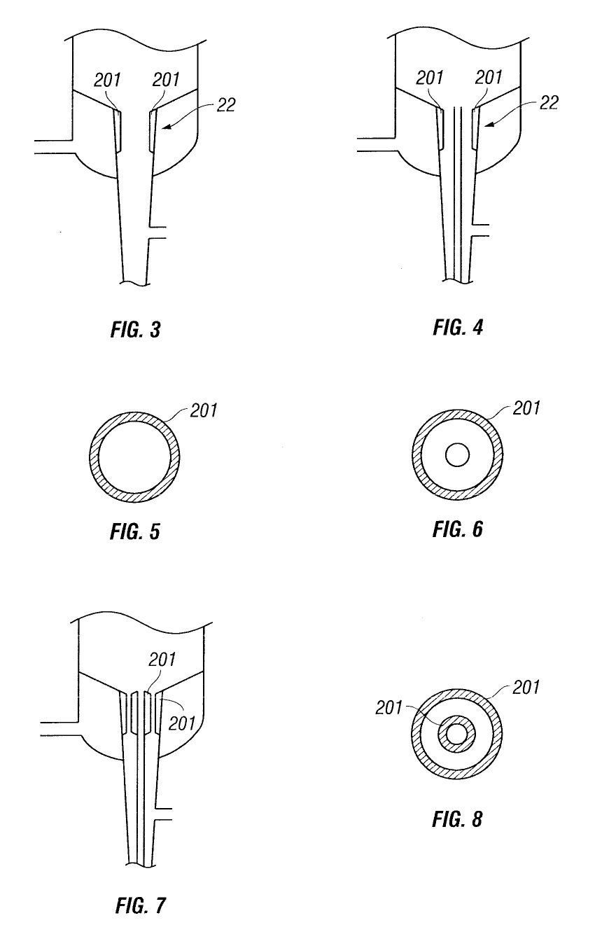

Referring additionally to FIGS. 3 and 4, there are shown an enlarged isolated view of passage 22 of vessel 10 of FIGS. 1 and 2, respectively. FIGS. 3 and 4 show various non-limiting embodiments of passage 22 having various annular shaped inserts 201 positioned therein. FIGS. 5 and 6 show a partial top view of inserts 201 of FIGS. 3 and 4, respectively.

FIGS. 7 and 8 are partial side and partial top views of various non-limiting embodiments of the annular passage having inserts 201 positioned therein. As contrasted with the inserts 201 of FIG. 4, which provides an insert only on one side of the annular passage, the inserts 201 of FIG. 7 provide an insert in on both the inner and outer sides of the annular passage. Certainly, the present invention contemplates that venturi inserts may be provided on the inner, outer or both sides of the annular space.

Those of skill in the art will appreciate that insert 201 may be secured in position by any suitable means. As non-limiting examples, insert 201 may be friction fit into place, may be held in place by a retaining member below and/or above, or may be secured with one or more fasteners or pegs.

In one non-limiting embodiment, the interchangeable venturi inserts 201 may be designed to provide different cross-sectional flow areas. This may allow changes in the velocity at a constant flow volume. Certainly, the present invention contemplates that inserts may be utilized to provide any suitable cross sectional area and velocity through the venturi as may be desired.

In one non-limiting embodiment, the interchangeable venturi inserts 201 may be designed to direct flow in any direction as desired, for example in the manner of a vent. This may allow changes in the flow pattern.

In another non-limiting embodiment, the interchangeable venturi inserts 201 may be designed to provide different shapes of cross-sectional areas. This may allow changes in the flow pattern and/or velocity of gas passing through the passage. FIG. 10 shows an insert 201 which may be utilized to change the shape of the passage from circular to a diamond shape. As non-limiting examples, a venturi insert may be inserted providing an oval, square, rectangular, triangular, and/or diamond shaped passage. Certainly, the present invention contemplates that inserts may be utilized to provide any suitable regular or irregular n-sided geometric shape of cross section as may be desired.

In another non-limiting embodiment, the interchangeable venturi inserts 201 may be designed to provide different surface flow properties. This may allow changes in the flow pattern passing through the passage. For example, a passage may have a smooth surface, and an insert may be inserted which will provide a roughened surface to affect flow through the passage. It is contemplated that any suitable surface feature may be provided, non-limiting examples of which include coated surfaces to provide any surface property, raised surfaces (i.e, ridges, bumps, convex features, and/or protrusions) and/or indented surfaces (dimples, indentions, convex features, and/or grooves).

In another non-limiting embodiment, the interchangeable venturi inserts 201 may be designed to provide different chemical and/or physical resistance. For example, when changing from the processing of a first type of material to a second type of material, it may be necessary to provide a venturi more suitable for the processing of the second type of material. As a non-limiting example, switching to a venturi insert with a treatment, coating or of a certain material that may resist chemical/physical degradation/attack when processing the second material.

In even another non-limiting embodiment, the interchangeable venturi inserts may be designed to provide different surface profiles along the gas flow travel path. This may allow for flow transition zones to control the gas flow. Thus, in addition to varying the diameter of the passage, the venturi inserts of the present invention may be utilized to provide a surface profile as may be desired. While, a valve will provide an abrupt change in the cross-sectional area, the venturi inserts of the present invention may allow for a transition from a first diameter to a second diameter. The surface profiles may be linear or curvilear as may be desired. Any number of embodiments are contemplated with one or multiple linear and/or curvilinear surfaces providing for one or more transition zones. As a non-limiting example, FIG. 11, is a partial view of an insert 201 having a plurality transition zones in the form of linear surfaces 220, 221, 222, 223 and 224. For example, going from surface points 204 to 205, the cross-sectional area/diameter of the passage will decrease because the slope of surface 220 there between. Going from surface points 205 to 206, the cross-sectional area/diameter of the passage will decrease because of the slope of surface 221, with the decrease along surface 221 being more rapid than along surface 220. Going from surface points 206 to 207, the cross-sectional area/diameter of the passage will remain relatively constant along surface 222. Going from surface points 207 to 208, the cross-sectional area/diameter of the passage will increase because of the slope of surface 223 there between. Going from surface points 208 to 209, the cross-sectional area/diameter of the passage will increase because of the slope of surface 224, with the increase along surface 223 being more rapid than along surface 224. Again,

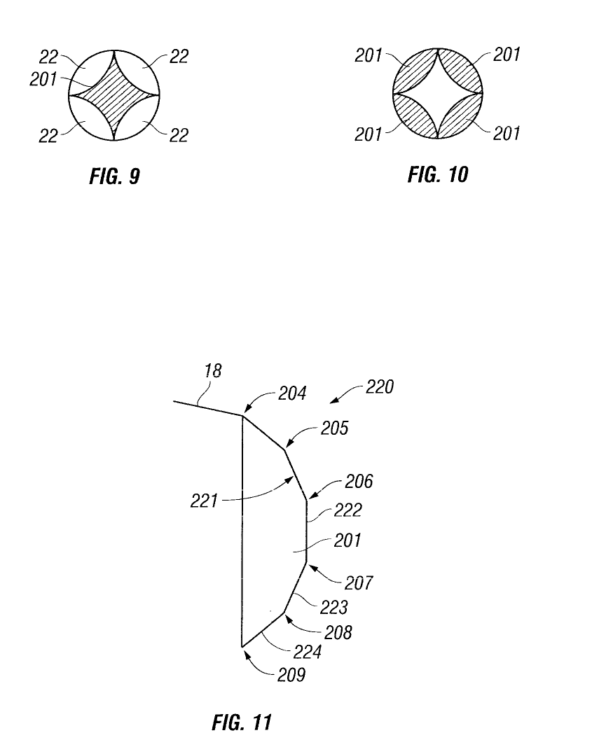

In still another non-limiting embodiment, the interchangeable venturi inserts 201 may be designed to provide various numbers of passages 22. FIG. 9 shows an insert 201 which breaks up the passage into a multiple number of passages. According to the present invention, an insert 201 may be utilized to break up the passage into any desirable number of passages of any suitable shape/size. These numbers of passages 22 may have the same or different cross-sectional areas, same or different cross-sectional shape, and/or the same or different surface profile.

In yet another non-limiting embodiment, the interchangeable venturi inserts incorporate any combination of the features discussed above.

The fluidized beds of the present invention having interchangeable inserts will be operated as is well known to those of skill in the art. Essentially air, enriched air, oxygen and steam are provided as the fluidizing medium. Particles of coal and ash are formed into a fluidized bed, and suitable conditions are provided to combust the coal thereby forming product gas. Ash particles are removed through the bottom of the fluidized bed. According to methods of the present invention, various interchangeable venturi inserts are utilized as necessary to select ash particles as desired.

The present invention has been described mainly by reference to coal gasification. It should be appreciated, that the present invention is not limited to coal gasification, but rather, finds utility in many applications in which fluidizing of particles is desired.

What is claimed is:

1. A fluidized bed apparatus comprising:
a vessel having a top and a bottom, defining a fluidized bed region between the top and bottom, and defining a passage at the bottom for introducing fluidizing medium and removing particulates; and,
a first venturi positioned in the passage, wherein the first venturi is interchangeable with a second venturi.

2. The apparatus claim 2, further comprising a second venturi for interchanging with the first venturi.

3. The apparatus claim 2, wherein the first venturi has a first cross-sectional area and the second venturi has a second cross-sectional area different than the first cross-sectional area.

4. The apparatus claim 2, wherein the first venturi has a first cross-sectional area of a first shape, and the second venturi has a second cross-sectional area of a second shape, with the first shape different than the second shape.

5. The apparatus claim 2, wherein the first venturi has a first surface profile, and the second venturi has a second profile, with the first profile different than the second profile.

6. The apparatus claim 2, wherein the first venturi has a first surface with first characteristics, and the second venturi has a second surface with second characteristics, with the first characteristics different than the second characteristics.

7. The apparatus claim 2, wherein the first venturi is suitable for use when fluidizing a first coal with first ash characteristics, and the second venturi is suitable for use when fluidizing a second coal with second ash characteristics, with the first characteristics different than the second characteristics.

8. A fluidized bed apparatus comprising:
a vessel having a top and a bottom, defining a fluidized bed region between the top and bottom, and defining a central passage at the bottom for introducing fluidizing medium, and further defining an annular passage around the central passage for removing particulates; and,
a first venturi positioned in the annular passage, wherein the first venturi is interchangeable with a second venturi.

9. The apparatus claim 8, further comprising a second venturi for interchanging with the first venturi.

10. The apparatus claim 9, wherein the first venturi has a first cross-sectional area and the second venturi has a second cross-sectional area different than the first cross-sectional area.

11. The apparatus claim 9, wherein the first venturi has a first cross-sectional area of a first shape, and the second venturi has a second cross-sectional area of a second shape, with the first shape different than the second shape.

12. The apparatus claim 9, wherein the first venturi has a first surface profile, and the second venturi has a second profile, with the first profile different than the second profile.

13. The apparatus claim 9, wherein the first venturi has a first surface with first characteristics, and the second venturi has a second surface with second characteristics, with the first characteristics different than the second characteristics.

14. The apparatus claim 9, wherein the first venturi is suitable for use when fluidizing a first coal with first ash characteristics, and the second venturi is suitable for use when fluidizing a second coal with second ash characteristics, with the first characteristics different than the second characteristics.

15. A method of fluidizing comprising:
introducing particles into a fluidizing bed region of a vessel; and,
removing particles through a first interchangeable venturi.

16. The method of claim 17, further comprising:
interchanging the first venturi with a second venturi.

17. The method of claim 16, wherein the first venturi has a first cross-sectional area and the second venturi has a second cross-sectional area different than the first cross-sectional area.

18. The method of claim 16, wherein the first venturi has a first cross-sectional area of a first shape, and the second venturi has a second cross-sectional area of a second shape, with the first shape different than the second shape.

19. The method of claim 16, wherein the first venturi has a first surface profile, and the second venturi has a second profile, with the first profile different than the second profile.

20. The method of claim 16, wherein the first venturi has a first surface with first characteristics, and the second venturi has a second surface with second characteristics, with the first characteristics different than the second characteristics.

21. The method of claim 16, wherein the first venturi is suitable for use when fluidizing a first coal with first ash characteristics, and the second venturi is suitable for use when fluidizing a second coal with second ash characteristics, with the first characteristics different than the second characteristics.
